(19) United States
(12) Patent Application Publication
(10) Pub. No.: US 2009/0251042 A1
(43) Pub. Date: Oct. 8, 2009

(54) Black Matrix Coating for a Display

(76) Inventor: Barry Michael Cushman, Lancaster, PA (US)

Correspondence Address: Thomson Licensing LLC, P.O. Box 5312, Two Independence Way, PRINCETON, NJ, 08543-5312, US

(21) Appl. No.: 12/227,467

(22) PCT Filed: Jun. 23, 2006
(86) PCT No.: PCT/US06/24811

§ 371 Date: Nov. 18, 2008

(51) Int. Cl. H01J 29/10; H01J 1/62; G02B 1/10

(52) U.S. Cl. 313/461; 313/496; 359/893

(57) ABSTRACT

A display screen of a color display is disclosed. The display screen includes a glass plate having an array of three different color-emitting phosphors thereon. A graphite-based matrix is placed in the interstitial regions between each of the three different color-emitting phosphors. The graphite-based matrix is formed from an aqueous composition including graphite, an alkali silicate and titanium dioxide.

### FIELD OF THE INVENTION

This invention relates to a color display and, more particularly to a color display having phosphor deposits on a faceplate panel.

### BACKGROUND OF THE INVENTION

Many color displays, such as, for example, color cathode-ray tubes (CRTs) and field emission devices (FEDs) typically include display screens. The display screens are formed from glass plates coated with an array of three different color-emitting phosphors. To provide contrast, a graphite-based matrix is placed in the interstitial regions between each of the three different color-emitting phosphors.

Many graphite-based matrix compositions lose adherence to glass and exhibits weak internal strength when physical contact is made thereto. During assembly of filed emission devices, spacers are placed in contact with the graphite-based matrix composition. Because of the weakness of the graphite matrix coating, adhesive failure may occur primarily at the coating/glass interface, such that the spacers may fall over. Adhesive failure may also occur within the body of the graphite-based matrix composition causing it to come away from the display screen.

Thus, a need exists for a graphite-based matrix composition with improved adhesion to a glass display screen.

### SUMMARY OF THE INVENTION

The present invention relates to a display screen of a color display. The display screen includes a glass plate having an array of three different color-emitting phosphors thereon. A graphite-based matrix is placed in the interstitial regions between each of the three different color-emitting phosphors. The graphite-based matrix is formed from an aqueous composition including graphite, an alkali silicate and titanium dioxide.

### BRIEF DESCRIPTION OF THE DRAWING

A preferred implementation of the principles of the present invention will now be described in greater detail, with relation to the accompanying drawings, in which:

FIG. 1 is a side view of a portion of a display screen of a color display including a graphite-based matrix of the present invention;

FIG. 2 is flow chart of the process for forming the graphite-based matrix of the present invention on the display screen of the color display; and

FIGS. 3A-3D depict views of the interior surface of the faceplate panel during formation of the luminescent screen assembly.

### DETAILED DESCRIPTION

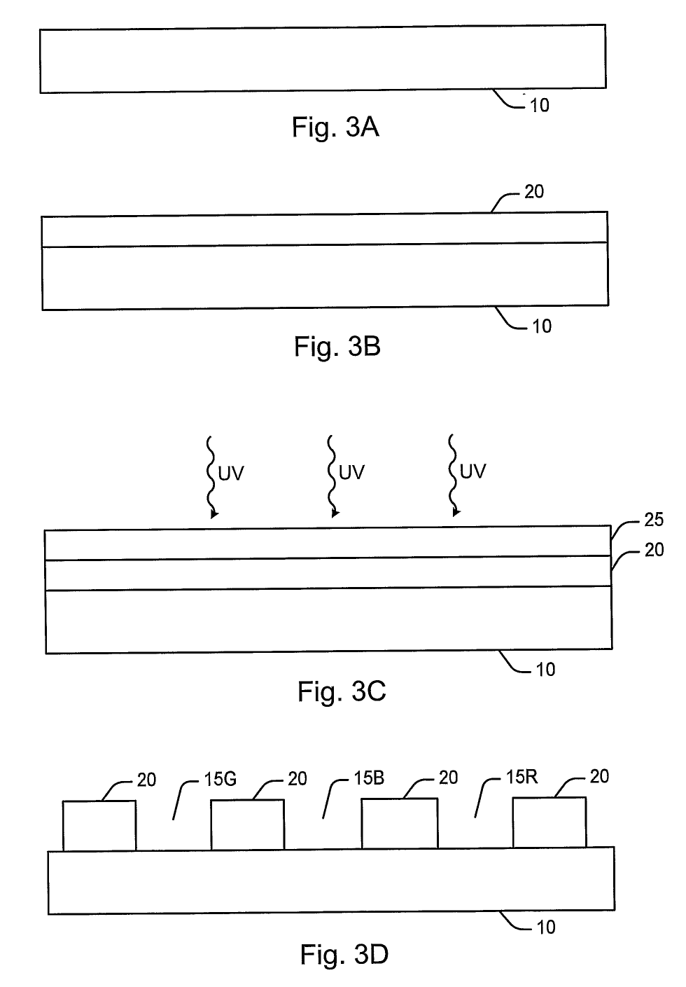

FIG. 1 shows a side view of a portion of a display screen 1 of a color display. The display screen 1 includes a glass plate 10 having an array of three different color-emitting phosphors 15G, 15B, 15R thereon. A graphite-based matrix 20 is placed in the interstitial regions between each of the three different color-emitting phosphors 15G, 15B, 15R. The exemplary display screen 1 described herein may be a faceplate panel for a color cathode-ray tube (CRT) as well as a field emission display (FEDs), among other display screens.

The graphite-based matrix is formed from an aqueous composition including graphite, an alkali silicate and titanium dioxide. The alkali silicate and titanium dioxide may be present in the aqueous composition in a ratio of about 1:1 to about 2.5:1 alkali silicate to titanium dioxide. Further, the aqueous composition should preferably include up to 12% by weight alkali silicate and titanium dioxide.

Suitable alkali silicates may include potassium silicate and sodium silicate. The titanium dioxide (TiO₂) should preferably be rutile (tetragonal crystals) or anatase (octangonal crystals) and the particle size distribution of the titanium dioxide powder should be less than about 1 micron.

An exemplary aqueous graphite-based matrix solution is formed by mixing 7.2 grams of Kasil 2135 potassium silicate (commercially available from PQ Corporation, Valley Forge, Pa.) in 76.8 grams of deionized water. After stirring, 2.8 grams of titanium dioxide powder having a particle size distribution less than about 1 micron is added to the potassium silicate solution. The titanium dioxide/potassium silicate mixture is then added with stirring to 25 grams Electrodag 1530 graphite dispersion (commercially available from Acheson Colloids Company, Port Huron, Mich.). The aqueous graphite-based matrix solution is further mixed on a jar roller for more than about 30 minutes. After mixing the graphite-based matrix composition should be applied to a display screen within about 24 hours to avoid agglomeration.

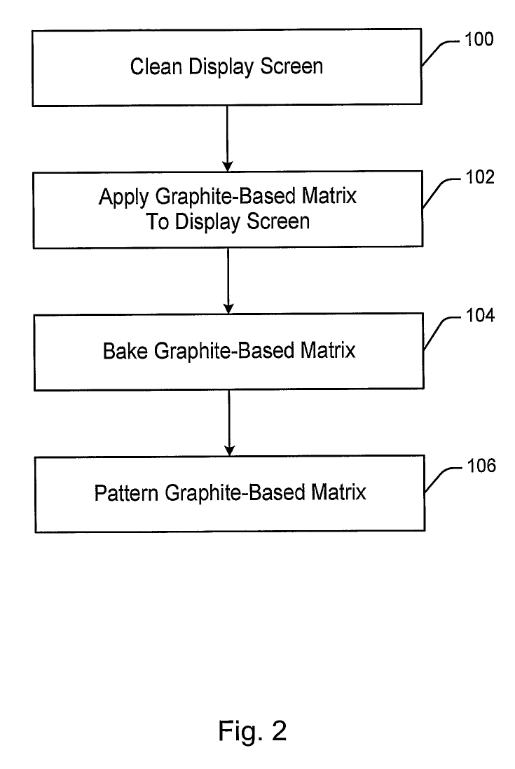

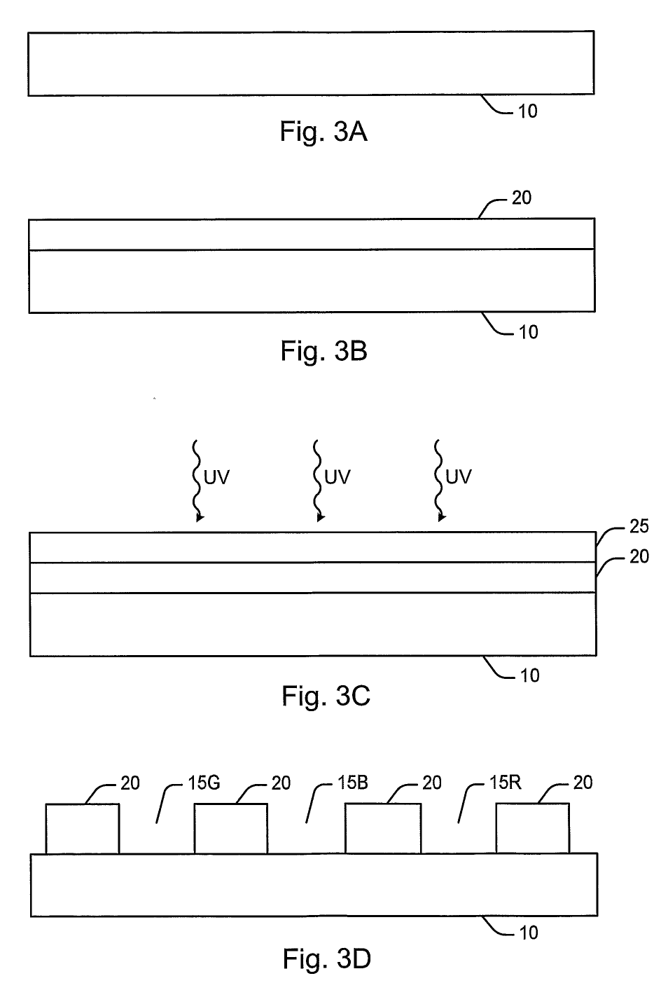

Referring to FIG. 2 and FIGS. 3A-3D, the method for forming the graphite-based matrix of the present invention on the display screen of the color display will be described. Initially, the interior surface of the display screen 10 is cleaned, as indicated by reference numeral 100 in FIG. 2 and FIG. 3A, by washing it with a caustic solution, rinsing it in water, etching it with buffered hydrofluoric acid and rinsing it again with water, as is known in the art.

As shown in FIG. 3B, the interior surface of the display screen 10 is then provided with the graphite-based matrix 20, as indicated by reference numeral 102. The graphite-based matrix 20 is uniformly applied over the interior surface of the display screen 10 using for example, a spin coating technique, as is known in the art. The graphite-based matrix preferably has a thickness of about 0.003 inches to about 0.010 inches. As indicated by reference numeral 104 in FIG. 2, after the graphite-based matrix is applied to the display screen 10, the display screen 10 is baked to about 450° C. for about 40 minutes to remove the water therefrom.

The graphite-based matrix 20 is patterned, as indicated by reference numeral 106 in FIG. 2, to form openings therein within which three different color-emitting phosphors 15G, 15B, 15R (FIG. 1) are deposited. Referring to FIG. 3C, the graphite-based matrix 20 is patterned by depositing a light sensitive material 25 thereon and irradiating portions of such layer to light, such as for example, ultraviolet (UV) light. The light sensitive material 25 is developed using, for example, deionized water. During development, portions of the light sensitive material 25 are removed. Thereafter, as shown in FIG. 3D, portions of the graphite-based matrix 20 are removed in regions where the three different color-emitting phosphors 15G, 15B, 15R are to be subsequently deposited.

The above-described graphite-based matrix composition has improved adherence to the glass of the color display screen. In addition, the graphite-based matrix composition has improved coating strength.

Although an exemplary color display screen for a color cathode-ray tube (CRT) or field emission device (FED) which incorporates the teachings of the present invention has been shown and described in detail herein, those skilled in the art can readily devise many other varied embodiments that still incorporate these teachings.

1. A display, comprising:
a display screen having a patterned light-absorbing matrix composition thereon defining a plurality of sets of fields, wherein the light-absorbing matrix includes graphite, an alkali silicate and titanium dioxide.

2. The display of claim 1 wherein the alkali silicate is selected from the group consisting of potassium silicate and sodium silicate.

3. The display of claim 1 wherein the alkali silicate and titanium dioxide are present in the light-absorbing matrix composition in a ratio of about 1:1 to about 2.5:1 alkali silicate:titanium dioxide.

4. The display of claim 1 wherein the light-absorbing matrix composition includes less than about 12% by weight of alkali silicate and titanium dioxide.

5. The display of claim 1 wherein the titanium dioxide (TiO₂) is one of rutile titanium dioxide and anatase titanium dioxide.

6. The display of claim 1 wherein the particle size distribution of the titanium dioxide in the light-absorbing matrix composition is less than about 1 micron.

7. A cathode-ray tube, comprising:
a display screen having a patterned light-absorbing matrix composition thereon defining a plurality of sets of fields, wherein the light-absorbing matrix includes graphite, an alkali silicate and titanium dioxide.

8. The cathode-ray tube of claim 7 wherein the alkali silicate is selected from the group consisting of potassium silicate and sodium silicate.

9. The cathode-ray tube of claim 7 wherein the alkali silicate and titanium dioxide are present in the light-absorbing matrix composition in a ratio of about 1:1 to about 2.5:1 alkali silicate:titanium dioxide.

10. The cathode-ray tube of claim 7 wherein the light-absorbing matrix composition includes less than about 12% by weight of alkali silicate and titanium dioxide.

11. The cathode-ray tube of claim 7 wherein the titanium dioxide (TiO₂) is one of rutile titanium dioxide and anatase titanium dioxide.

12. The cathode-ray tube of claim 7 wherein the particle size distribution of the titanium dioxide in the light-absorbing matrix composition is less than about 1 micron.

13. A field emission device, comprising:
a display screen having a patterned light-absorbing matrix composition thereon defining a plurality of sets of fields, wherein the light-absorbing matrix includes graphite, an alkali silicate and titanium dioxide.

14. The field emission device of claim 13 wherein the alkali silicate is selected from the group consisting of potassium silicate and sodium silicate.

15. The field emission device of claim 13 wherein the alkali silicate and titanium dioxide are present in the light-absorbing matrix composition in a ratio of about 1:1 to about 2.5:1 alkali silicate:titanium dioxide.

16. The field emission device of claim 13 wherein the light-absorbing matrix composition includes less than about 12% by weight of alkali silicate and titanium dioxide.

17. The field emission device of claim 13 wherein the titanium dioxide (TiO₂) is one of rutile titanium dioxide and anatase titanium dioxide.

18. The field emission device of claim 13 wherein the particle size distribution of the titanium dioxide in the light-absorbing matrix composition is less than about 1 micron.
